(19) United States
(12) Patent Application Publication
(10) Pub. No.: US 2011/0195516 A1
(43) Pub. Date: Aug. 11, 2011

(54) WIRE GRID SUBSTRATE STRUCTURE AND METHOD FOR MANUFACTURING SUCH A SUBSTRATE

(75) Inventors: Neriman Nicoletta Kahya, Eindhoven (NL); Derk J.W. Klunder, Geldrop (NL)

(73) Assignee: KONINKLIJKE PHILIPS ELECTRONICS N.V., EINDHOVEN (NL)

(21) Appl. No.: 13/062,568

(22) PCT Filed: Sep. 8, 2009
(86) PCT No.: PCT/IB2009/053916

§ 371 Date: Mar. 7, 2011

(30) Foreign Application Priority Data
Sep. 9, 2008 (EP) 08163915.5

(51) Int. Cl. G01N 21/76; G01N 21/64; B05D 5/06; B05D 3/00; B32B 3/10

(52) U.S. Cl. 436/172; 422/82.08; 427/162; 428/138

(57) ABSTRACT

The present invention relates to a multi-layered substrate structure comprising at least one carrier layer (11), a first layer (12), said carrier layer and first layer being in contact with each other, and at least one second layer with a chemical composition different from the first layer (13) said first and second layer being in contact with each other, the second layer forming apertures each having at least one in-plane dimension (W1) smaller than the diffraction limit, the diffraction limit being defined by a radiation wavelength of the excitation light. The invention further relates to the use and manufacturing process of such a substrate structure and a luminescence sensor.

### FIELD OF THE INVENTION

The invention relates to a multi-layer substrate structure for use in a sensor. Moreover, the invention relates to a method for use and manufacturing this multi-layered substrate structure and a luminescence sensor comprising the multi-layer substrate structure.

### BACKGROUND OF THE INVENTION

Biosensors are devices that are able to detect the presence or quantitatively measure a target molecules such as e.g., but not limited thereto, proteins, viruses, bacteria, cell components, cell membranes, spores, DNA, RNA, etc. in a sample such as for example blood, serum, plasma and saliva. The target molecules also are called analyte. A biosensor can use a surface that comprises specific recognition elements for capturing the analyte. Such surface may be modified by attaching specific molecules to it, which are suitable for binding the target substances which are present in the sample fluid. These molecules are called molecular ligands. Examples of such molecular ligands are nucleotide probes, antibodies etc. Interfacing the active surface area of biosensors to biomolecules such as molecular ligands mostly relies on tailored chemistry to covalently attach them to the surface, thereby facilitating the subsequent binding of the specific target of interest.

Micro- or nano-porous substrates (membranes) have been proposed as biosensor substrates that combine a large area with rapid binding kinetics. An example of such a sensor is shown in EP-06766040-A where different wire gird compositions on a glass substrate are disclosed. The active area of this biosensor consists of wiregrids deposited on glass. In particular, by using patterns with sub-diffraction-limited wires, the intensity of the incident polarized light is significant only within a 20-30 nm layer near the surface and it is suppressed beyond that leading to detection of local binding.

Especially when the analyte concentration is low (e.g. below 1 nM, or below 1 pM) the diffusion kinetics play an important role in the total performance of a biosensor assay. For optimal binding efficiency of the analyte to the specific molecular ligands, specific surface areas and short diffusion lengths are highly favorable.

### SUMMARY OF THE INVENTION

It is an object of the present invention to optimize local binding efficiency in a sensor, such as a luminescence sensor, thereby improving signal-to-noise ratio.

This objective is realized by a multi-layer substrate structure for use in a luminescence sensor to be illuminated with excitation light, comprising

at least one carrier layer (11),

a first layer (12), said carrier layer and first layer being in contact with each other, and

at least one second layer (13) with a chemical composition different from the first layer said first and second layer being in contact with each other, the second layer forming apertures each having at least one in-plane dimension (W1) smaller than the diffraction limit, the diffraction limit being defined by a radiation wavelength of the excitation light.

The substrate according to the present invention comprises a first layer forming a surface, and second layer forming wires placed such that apertures are formed having at least one in-plane dimension (W1) smaller than the diffraction limit of the excitation light. The two layers have a different chemical composition, e.g. are made of two different materials. By using two different chemical compositions, the first layer forming a surface between the wires can behave chemically different to the second layer, the wires. By using these different chemical properties, binding of biomolecules can be facilitated on only one of the layers.

Parasitic concentration depletion is a process where binding of a target molecule is not restricted to the site where this target is detected. This will result in a reduction of binding rate of the target within the detection area. Minimizing the binding of target molecules to inactive sensing areas, e.g. binding to the second layer will result in a induction of binding rate of the target within the detection area.

The parasitic concentration depletion is limited in the present substrate structure by minimizing the binding of target molecules to inactive sensing areas.

Preferably, the carrier layer and the first layer are substantially permeable for the excitation light in order to enable placing a light source and or a detector under the substrate. With substantially permeable is meant a transmission for the excitation light of at least 10%, preferably better than the 1/e (36.8%).

More preferably, the first layer has a thickness of 5 to 10 nm. This thickness allows for the excitation light to pass through the layer. For a first layer made of gold, it follows from the imaginary refractive index (source: Palik) that the 1/e intensity decay length is between 11 and 21 nm for wavelengths of the light between 200 nm and 1100 nm.

In a preferred embodiment, the first layer comprises an inert metal, preferably selected from the group comprising gold, titanium, platinum and palladium or combinations thereof.

In a preferred embodiment, the second material forming the wires is aluminum, aluminum oxide or combinations thereof.

In a preferred embodiment, the first layer is chemically modified to facilitate molecular target immobilization. Efficient target immobilization is one of the essential features of a biosensor. Following immobilization, the amount of analyte binding can be visualized. In order to attach biomolecules to a surface the surface can to be modified for example via sulfur or amine chemistry.

In a preferred embodiment, the surface of the first layer is functionalized with thiol groups. Thiols covalently attach on a metal surface via the S atoms providing an elegant and easy way to covalently provide anchors for biomolecules such as molecular ligands or probes. Preferably, the thiol molecules comprise an acyl chain with a length of 10 to 18 carbon atoms.

Preferably, the surface of the first layer is functionalized with molecular ligands, including but not limited to specific capture probes. Molecular ligands may be nucleic acids such as a DNA, RNA, aptamers, antibodies, Fab fragments, Fc tails. They may be proteins, such as e.g. receptors, antibodies. Antibodies may be used in form of polyclonal or/and monoclonal antibodies. A molecular ligand may be a drug or a cell or other chemical compounds.

In a preferred embodiment, the second layer is not functionalized. Not functionalized means that the functional groups are specifically positioned on the first and not on the second layer. This however does not exclude the presence of some functional groups on the second layer. The amount of functional groups present on the second layer is preferably lower than 20%, even more preferably lower than 10% compared to the amount present on the first layer.

The invention further relates a luminescence sensor comprising the multi-layer substrate structure according to claim 1, an excitation radiation source (31) for irradiating the sensor and a detector (32) for detecting luminescence radiation. Preferably, the luminescence sensor is a luminescence bio sensor.

The invention additionally relates to a method for manufacturing a substrate structure according to the invention, comprising the following steps:

providing a carrier layer (11),

adding a first layer on top of the carrier layer (12)

adding a second layer on top of the first layer (13)

defining apertures with at least one in-plane dimension (W1) smaller than a diffraction limit by pattering of said second layer.

The invention also relates to the use of a substrate structure according to the invention, and a luminescence sensor for the detection of target molecules.

### BRIEF DESCRIPTION OF THE DRAWINGS

FIG. 1: A substrate structure according to an embodiment of the invention.

FIG. 2: Chemical modification of the substrate structure

FIG. 3: Luminescence sensor

### DETAILED DESCRIPTION OF THE EMBODIMENTS

The multi-layered substrate structure and the luminescence sensor system according to the present invention are very suitable for the qualitative or quantitative detection of target components, wherein the target components may for example be biological substances like biomolecules, complexes, cell fractions or cells. The term “target” shall denote any particle (atom, molecule, complex, nanoparticle, microparticle etc.) that has some property (e.g. optical density, magnetic susceptibility, electrical charge or luminescence), including a possible label particle which can be detected, thus (indirectly) revealing the presence of the associated target component. A “target” and a “label particle” may be identical.

Interfacing the active surface area of biosensors to biomolecules mostly relies on tailored chemistry to covalently attach molecular ligands, e.g. capture probes to the surface and thereby facilitating the catching of a specific target of interest.

Glass surfaces can be easily modified with alkylsilyl aldehydes in order to expose aldehyde groups, which would react with primary amines present in abundance in biomolecules (proteins, synthetic oligonucleotides). In a similar way, epoxysilanes can be employed for the same purpose, thereby coating the surface with epoxide groups which react with primary amines. Alternatively, treatment with aminosilanes would expose amino groups on the glass surface, which cross-link with biomolecules with or without aminogroups e.g. the phosphate groups of the DNA backbone are sufficient for stable and efficient binding upon exposure to UV light. However, these modification strategies are efficient not only on glass but also on Al/Al₂O₃, which is a preferred material for a wire grid pattern for use in an optical sensor.

In conventional wire grid substrates, aluminum wire grids are deposited onto glass substrates with spacing W1 (the open space between the wires) below the diffraction limit in the medium that fills the space between the wires. A preferred value for the space between the wires is 70 nm, which results—for an open/closed ratio of 1/1—in a period of 140 nm. Here the diffraction limit in the medium that fills the space between the wires is defined as the ratio between 0.5 times the wavelength (in vacuum) and the real part of the refractive index of the medium that fills the space between the wires. In case of a periodic structure, which is preferred as this results in the largest area of the first layer available for binding, it is preferred to have a periodic spacing below the diffraction limit to avoid parasitic diffraction effects. Taken into account these considerations, it is preferred to have values for the space between wires of less than 140 nm, preferably less than 100 nm for excitation wavelengths smaller than 700 nm. The effective measurement volume is reduced to a thin layer of only 20 to 30 nm (depending on the spacing of the wires) above the glass surface; the excitation light has a decay length of 20-30 nm. The surface of the Al wires is, in ambient conditions, oxidized (Al₂O₃). Conventional strategies of covalent attachment of capture probes onto such a nanostructured surface comprise of silanization of the glass and, consequently, also of the Al wires. As a consequence of that, molecular targets can attach not only to the glass surface between the wires but also on the wires themselves, thereby decreasing the sensitivity of the sensor due to parasitic concentration depletion. This implies that the target of interest can bind everywhere between and on the wires, whereas the active sensing area is limited to the glass surface between the wires. Parasitic concentration depletion can be reduced by minimizing the binding of target molecules to inactive sensing areas; binding of target molecules to active sensing areas also results in concentration depletion, but this is acceptable as this also results in an increase of the measured signal. Specific targeting of molecular ligands to the layer between wires would be favorable to increase detection sensitivity.

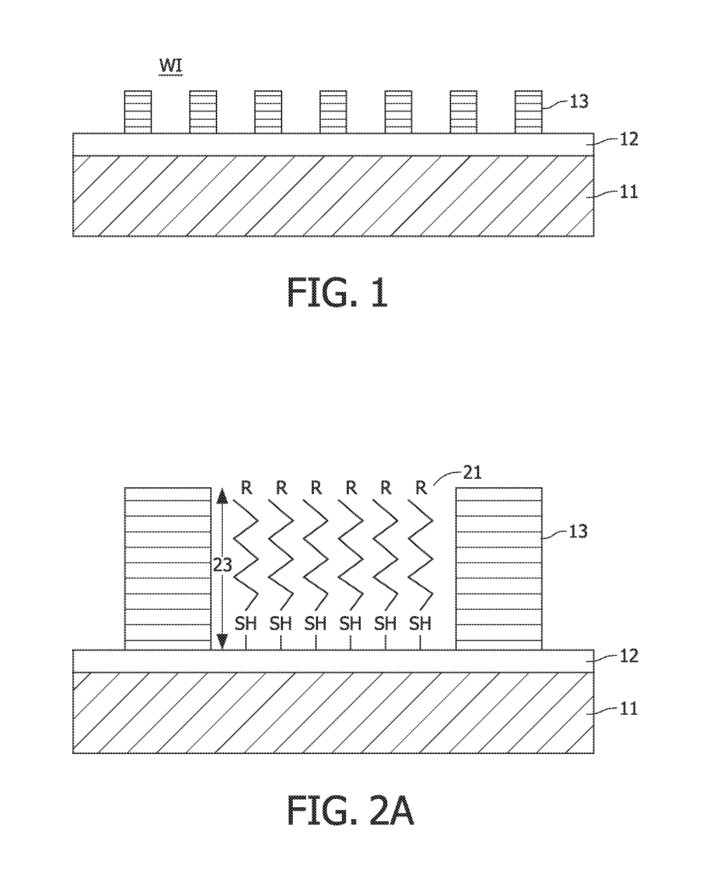

It is preferable to provide a substrate that has a different chemical composition between the wires compared to the wires itself, so selective binding of the target can be achieved. FIG. 1 shows a schematic outline of such a substrate. A carrier layer 11 is covered by a first layer 12 of a first material. On top of this first layer a second layer 13 is placed that forms the wires of the wire grid forming apertures each having at least one in-plane dimension (W1) smaller than the diffraction limit, the diffraction limit being defined by a radiation wavelength of the excitation light.

Preferably, the first layer is substantially formed of an inert metal. The chemical character of an inert metal is different from to that of pure Al and/or Al oxide, so that a specific chemical treatment will affect the inert metal but not the wires and vice versa. In order to immobilize molecular targets only on the surface between the wires, in a first example, the first layer is chemically modified to facilitate molecular target immobilization. Several modifications can be envisioned, being a modification that facilitates later binding of a probe or ligand specific for a target. Second, a modification is envisioned where the first layer is modified in such a way to comprise molecular ligands for target binding. A third option can be a modification of the first layer that facilitates immediate binding of the target, without the need of a specific molecular ligand.

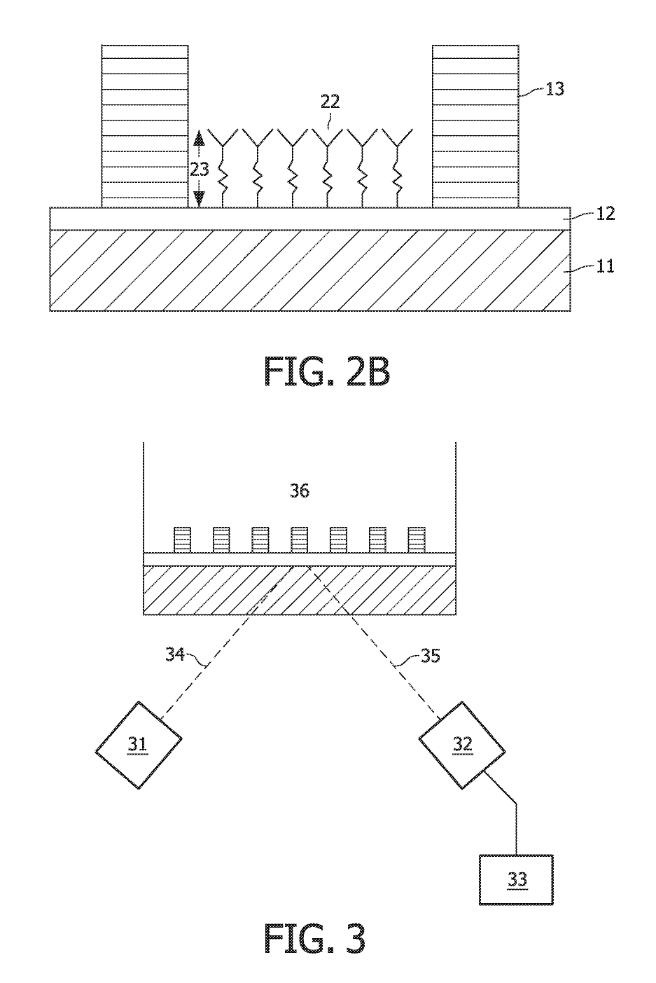

An example of a possible chemical modification of the first layer can be a reaction of the first layer substantially formed of an inert metal with thiols, which covalently attach on the metal surface via the S atoms. This is schematically represented in FIG. 2A. Depending on the thiols used, they may reorient on the surface, thereby forming molecular stacks, so-called self-assembled monolayers 23 (SAMs). Preferably, the thiol molecules comprise an acyl chain with a length of 10 to 18 carbon atoms. If the thiols contain specific functional groups (R) (e.g. carboxylates, thiols, amines), these groups will be exposed onto the surface and serve as anchors to covalently immobilize molecular targets (21, FIG. 2). By adopting this strategy, biomolecules will specifically bind onto the active sensor area between the wires, thereby increasing the sensor sensitivity. FIG. 2B shows the covalent attachment of biomolecules or molecules or molecular ligands via thiol molecules from FIG. 1A. As an example, antibodies 22 are linked to the sensor surface 12. Non-specific molecular attachment on the wiregrid can be additionally prevented by conventional blocking reagents (e.g. BSA).

The substrate structure according to the invention can be used in a luminescence sensor system on order to facilitate target binding measurements. This luminescence sensor system, according to an aspect schematically represented in FIG. 3, preferably comprises the following components:

a) A substrate comprising a carrier layer, a first layer and a second layer. In a transmissive arrangement, the carrier preferably has a high transparency for light of a given spectral range, particularly light emitted by the light source that will be defined below. The carrier of the substrate may for example be produced from glass or some transparent plastic. The carrier may be permeable; it provides a carrying function for aperture defining structures provided on the carrier having a smallest in plane aperture dimension (W1) smaller than a diffraction limit.

The substrate comprises a first binding surface layer at which target components can collect. The term “binding surface” is chosen here primarily as a unique reference to the surface of the first layer of material. On the binding surface a second layer is provided, for providing evanescent radiation, in response to the radiation incident at the binding surface, in a detection volume bound by the binding surface and extending over a decay length away from the binding surface into a sample chamber. It is noted that the term “evanescent radiation” in a given medium refers to non-propagating waves having a spatial frequency that is larger than the wave-number of a given medium (that is the wave-number in vacuum times the refractive index of the medium). According to the present invention, evanescent waves are generated by total internal reflection or by incidence on a sub-diffraction limited apertures being the second layer according the present invention. In particular, the evanescent wave-field will decay with a l/e decay length of typically 10-500 nm depending on the illumination light. In addition, it is noted that the optical structure is preferably of a kind that the evanescent field substantially does not propagate through the optical structure, which means that an out of plane dimension of the aperture defining structure is substantially larger than the l/e decay length.

b) A source 31 for emitting a beam of radiation 34, called “incident light beam” in the following, into the aforementioned carrier such that it is reflected, at least in an investigation region at the binding surface of the carrier. The light source may for example be a laser or a light emitting diode (LED), optionally provided with some optics for shaping and directing the incident light beam. The investigation region may be a sub-region of the binding surface or comprise the complete binding surface; it will typically have the shape of a substantially circular spot that is illuminated by the incident light beam.
c) A detector 32 for detecting radiation 35 from the target component present in the detection volume 36, in response to the emitted incident radiation from the source, possibly connected to a recording module 33. It is noted that the term “radiation from the target component” includes any radiation that is suitable for detecting a presence of the target component, possibly including any label particles. Without limitation, the radiation may be of a scattered, reflected or luminescent type. The detector may comprise any suitable sensor or plurality of sensors by which light of a given spectrum can be detected, for example a photodiode, a photo resistor, a photocell, or a photo multiplier tube. Where in this specification the term light or radiation is used, it is meant to encompass all types of electromagnetic radiation, in particular, depending on context, as well visible as non visible electromagnetic radiation.

The sensor device according to the invention allows a sensitive and precise quantitative or qualitative detection of target components in an investigation region at the binding surface. One advantage of the described optical detection procedure comprises its accuracy as the evanescent waves explore only a small volume that extends typically 10 to 30 nm into the aperture from the end of the aperture adjacent to the carrier, thus avoiding disturbances such as scattering, reflection, luminescence from the bulk material behind this volume.

The luminescence sensor system may be used for a qualitative detection of target components, yielding for example a simple binary response with respect to a particular target molecule, present or not-present. The luminescence sensor system may however comprise an evaluation module for quantitatively determining the amount of target components in the investigation region from the detected reflected light. This can for example be based on the fact that the amount of light in an evanescent light wave, that is absorbed or scattered by target components, is proportional to the concentration of these target components in the investigation region. The amount of target components in the investigation region may in turn be indicative of the concentration of these components in a sample fluid that is in communication with the aperture according to the kinetics of the related binding processes.

A sample in the context of the present invention may originate from a biological source. Encompassed are biological fluids such as lymph, urine, cerebral fluid, bronco leverage fluid (BAL), blood, saliva, serum, feces or semen. Also encompassed are tissues, such as epithelium tissue, connective tissue, bones, muscle tissue such as visceral or smooth muscle and skeletal muscle, nervous tissue, bone marrow, cartilage, skin, mucosa or hair. A sample in the context of the present invention may also be a sample originating from an environmental source, such as a plant sample, a water sample, a soil sample, or may be originating from a household or industrial source or may also be a food or beverage sample. A sample in the context of the present invention may also be a sample originating from a biochemical or chemical reaction or a sample originating from a pharmaceutical, chemical, or biochemical composition. Where appropriate, as for instance in the case of solid samples or viscous suspensions, the sample may need to be solubilised, homogenized, or extracted with a solvent prior to use in the present invention in order to obtain a liquid sample. A liquid sample hereby may be a solution or suspension. Liquid samples may be subjected to one or more pre-treatments prior to use in the present invention. Such pre-treatments include, but are not limited to dilution, filtration, centrifugation, pre-concentration, sedimentation, dialysis, lysis, eluation, extraction. Pre-treatments may also include the addition of chemical or biochemical substances to the solution, such as acids, bases, buffers, salts, solvents, reactive dyes, detergents, emulsifiers, chelators, enzymes, chaotropic agents.

In the context of the invention described herein, expressions like “the” “a” or “one” and equivalent expressions are not to be understood as referring to a single entity, but to a plurality of identical entities, unless specified otherwise. The singular is used herein for the convenience of the reader.

The terms or definitions are provided solely to aid in the understanding of the invention. Unless specifically indicated, these definitions should not be construed to have a scope less than understood by a person of ordinary skill in the art. Other variations to the disclosed embodiments can be understood and effected by those skilled in the art in practicing the claimed invention, from a study of the drawings, the disclosure, and the appended claims

### Example 1

### Manufacturing of Substrate Structure According to the Invention

On a transparent glass substrate a 5-10 nm thick Au layer is evaporated, followed by evaporation of a 160 nm thick aluminum layer. On top of the aluminum layer, a sol gel mask is defined by sol gel embossing (reference: M. Verschuuren, and H. van Sprang, “3D Photonic Structures by Sol-Gel Imprint Lithography,” MRS 2007 Spring Meeting (San Francisco) (Vol. 1008, 2007)). The wires are defined by etching into the Aluminum layer down to the gold layer.

### Example 2

### Self-Assembled Monolayer (SAM) Coating of Substrate Structure

Place substrate with a first layer of an inert metal in glass bottle containing: MercaptoUndecanoic acid ═HS—C₁₀H₂O—COOH dissolved in ethanol (SAM solution).

Incubate at room temperature in the dark for 3 h.

Take out substrate and rinse with ethanol

Dry substrate with nitrogen gun

Weigh 76.6 mg 1-Ethyl-3[3-dimethylaminopropyl]carbodiimide hydrochlorid (EDC) per ml H₂O.

Weigh 12.5 mg N-hydroxysulfosuccinimide (NHS) per ml H₂O.

Mix EDC and NHS in 1:1 ratio just before use and put a droplet on the substrate.
Incubate for 7 minutes in a humid atmosphere.

Rinse substrate for 1s with water using a siphon.

Dry substrate using a nitrogen gun.

Put a droplet of antibody/capture probe (1 mg/ml) on the chip. Incubate for 30 minutes in a humid atmosphere in dark.

Rinse substrate for is with 1× Phosphate buffered saline (PBS) using a siphon.

Dry substrate using a nitrogen gun.

Substrate is ready for use.

1. A multi-layer substrate structure for use in a sensor to be illuminated with excitation light, comprising
at least one carrier layer (11),
a first layer (12), said carrier layer and first layer being in contact with each other, and
at least one second layer (13) having a chemical composition different from the first layer said first and second layer being in contact with each other, the second layer forming apertures each having at least one in-plane dimension (W1) smaller than the diffraction limit, the diffraction limit being defined by a radiation wavelength of the excitation light.

2. The substrate structure according to claim 1, wherein the carrier layer and the first layer are substantially permeable for the excitation light.

3. The substrate structure according to claim 1, wherein the first layer has a thickness of 5 to 10 nm.

4. The substrate structure according to claim 1, wherein the first layer comprises an inert metal.

5. A substrate structure according to claim 1, wherein the second layer is substantially formed of aluminum, aluminum oxide or combinations thereof.

6. The substrate structure according to claim 1, wherein the first layer is chemically modified to facilitate molecular target immobilization.

7. The substrate structure according to claim 6, wherein the surface of the first layer is functionalized with thiol groups.

8. The substrate structure according to claim 1, wherein the surface of the first layer is functionalized with molecular ligands.

9. The substrate according to claim 7 wherein the second layer is not functionalized.

10. A luminescence sensor comprising the multi-layer substrate structure according to claim 1, an excitation radiation source (31) for irradiating the sensor and a detector (32) for detecting luminescence radiation.

11. A method for manufacturing a substrate structure according to claim 1, comprising the following steps:
providing a carrier layer (11),
adding a first layer on top of the carrier layer (12)
adding a second layer (13) on top of the first layer
defining apertures with at least one in-plane dimension (W1) smaller than a diffraction limit by pattering of said second layer.

12. The method according to claim 11 wherein the first and or second layer are added via evaporation.

13. A method according to 11 wherein the first layer is chemically modified to facilitate capture probe binding.

14. Use of the substrate structure according to claim 1 for the detection of target molecules.
